(19) United States
(12) Patent Application Publication
(10) Pub. No.: US 2025/0198816 A1
(43) Pub. Date: Jun. 19, 2025

(54) SYSTEMS AND METHODS OF HIGH ACCURACY FLOW MEASUREMENTS

(71) Applicant: Sensia Netherlands B.V., Rotterdam (NL)

(72) Inventor: Gregor James Brown, Prestwick (GB)

(21) Appl. No.: 18/544,385

(22) Filed: Dec. 18, 2023

(51) Int. Cl. G01F 1/667; G01F 25/10

(52) U.S. Cl. CPC G01F 1/667; G01F 25/10

(57) ABSTRACT

Systems and methods provided herein relate to an ultrasonic measurement system. The system includes transducers configured to provide ultrasonic signals and metering electronics configured to receive electronic signals associated with the ultrasonic signals. The metering electronics are configured to provide a correction function which is a function of measured or estimated values that are dependent on both flow velocity and speed of sound.

### BACKGROUND

The present disclosure relates to flow meters. Flow meters can be used to measure fluids (e.g., production fluids and/or injection fluids) passing through conduits.

In some instances, operators use ultrasonic flow meters for measurements of flow and volume. Some electronic flow meters determine flow based on principles of ultrasonic transit time measurement. Ultrasonic transit time measurement flow meters are used in a wide variety of applications, including measurement of gaseous and liquid fluids. One such application is custody measurement of gaseous hydrocarbons, where high accuracy is desired because the monetary value of the fluid is high. Ultrasonic flow meters include ultrasonic transducers for transmitting and detecting ultrasonic waves (e.g., ultrasonic signals) in the fluid passed through a conduit. The flowing fluid interacts with the ultrasonic signals transmitted through the fluid. This allows the received ultrasonic signals to be used to infer characteristics of the fluid, such as velocity and volumetric flow rate.

A transit time measurement based ultrasonic flow meter quantifies fluid flow based on the transit time of signals propagating upstream and/or downstream relative to the fluid flow. Typically transit times are measured in both the upstream and downstream directions. For example, U.S. Pat. No. 4,300,400, titled “Acoustic Flowmeter with Reynolds Number Compensation” discloses one such transit time measurement based ultrasonic flow meter. U.S. Pat. Nos. 9,304,024, 10,288,462 and 10,393,568 describe electronic flow meters and are incorporated by reference in their entireties. There is a need for high accuracy flow meters.

### SUMMARY

One implementation of the present disclosure relates to an ultrasonic measurement system. The system includes transducers configured to provide ultrasonic signals and metering electronics configured to receive electronic signals associated with the ultrasonic signals. The metering electronics are configured to provide a correction function being a function of measured or estimated values that are at least partially dependent on both flow velocity and speed of sound. In some embodiments, the correction function uses a correlation parameter that has a velocity related term with an exponent greater than zero on a numerator and a speed of sound related term with an exponent greater than zero on a denominator or vice-versa. In some embodiments, the exponent for the velocity related term is approximately 1 and the exponent for the speed of sound related term is between approximately 1 and 3.

In some embodiments, the correlation parameter takes a form of X=ν/cⁿ with n between 1 and 2, ν is velocity and c is the speed of sound. In some embodiments, n is not an integer. In some embodiments, the flow velocity related term is determined using measurements of ultrasonic transit time using the electronic signals. In some embodiments, the speed of sound related term is determined using measurements of ultrasonic transit time using the electronic signals. In some embodiments, the correction function is applied to transit time measurement results directly. In some embodiments, the correction function uses transit time measurements indirectly, whereby the correction function is applied using a variable derived from the transit time measurements.

In some embodiments, the correction function uses a flow velocity variable. In some embodiments, the correction function uses a speed of sound variable.

One implementation of the present disclosure relates to a method of determining flow rate. The method includes providing ultrasonic signals in a conduit associated with a flow, determining ultrasonic transit time using the ultrasound signals, and determining velocity in response to the ultrasonic transit time. The method also includes determining a correction term using a speed of sound parameter and a velocity parameter and determining the flow rate using the velocity. The correction term is applied to the transit time, the velocity or the flow rate.

Some embodiments relate to a method of determining a corrected flow rate. The method includes providing ultrasonic signals in a conduit associated with a flow, determining ultrasonic transit time using the ultrasonic signals, determining a correction term using a velocity parameter and a speed of sound parameter, and determining the corrected flow rate, wherein the correction term is applied to the ultrasonic transit time, a velocity calculated from the ultrasonic transit time, or a flow rate when determining the corrected flow rate. In some embodiments, the correction term is calculated or is determined using a look up table.

In some embodiments, the correction term is applied to the velocity to provide a corrected velocity. In some embodiments the correction term is applied as function of a correlation parameter. In some embodiments, the correction term is applied to the transit time measurement to provide a corrected transit time and hence a corrected velocity measurement for use when determining the flow rate. In some embodiments, the correlation parameter has a velocity related term in a numerator and a speed of sound related term with an exponent greater than zero in a denominator or vice-versa. In some embodiments, the correction term is used correct the result (multiply, divide, add or subtract) and the correlation parameter X is calculated to determine the value of the correction term. The correction term and the correlation parameter can be represented by a correction function R=f(X) (i.e. R is a function of X), with R being the correction term and X being the correlation parameter, (e.g., R being the y-axis value and X being the x-axis value of the correction function).

In some embodiments, an exponent for the velocity related term is approximately 1 and the exponent for the speed of sound related term is between approximately 1 and 3. In some embodiments, the correction function R=f(X), where R is the correction term and X is the correlation parameter which takes a form of X=ν/cⁿ with n between 1 and 2, ν is flow velocity and c is speed of sound.

One implementation of the present disclosure relates to a flow meter. The flow meter includes a meter body, ultrasonic transducers disposed in the meter body and metering electronics. The metering electronics are configured to determine ultrasonic transit time using the ultrasound signals in the meter body, velocity in response to the transit time, a correction function using a velocity and a speed of sound parameter, and a flow rate using the velocity. The correction function is used to improve the accuracy of the flow rate.

In some embodiments, the correction function uses a correlation parameter having a velocity related term with an exponent greater than zero on a numerator and a speed of sound related term with an exponent greater than zero on a denominator or vice-versa.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below:

FIG. 1 is a general block diagram of a flow measurement system including a correction module according to some embodiments.

FIG. 2 is a perspective cross-sectional view schematic drawing of a flow meter, which can be implemented in or as the flow measurement system illustrated in FIG. 1, according to some embodiments.

FIG. 3 is a schematic drawing of path geometry associated with velocity measurement operations of the flow measurement system illustrated in FIG. 1, according to some embodiments.

FIG. 4 is a schematic drawing of three wavelet paths between transducer housing transmitting and receiving surfaces associated with velocity measurement operations of the flow measurement system illustrated in FIG. 1, according to some embodiments.

FIG. 5 includes graphs showing transit time distribution associated with velocity measurement operations of the flow measurement system illustrated in FIG. 1, according to some embodiments.

FIG. 6 is a graph showing amplitude versus time for three wavelets with different transit times, according to some embodiments.

FIG. 7 is a graph showing amplitude versus time for a composite signal with zero transit time spread between wavelets according to some embodiments.

FIG. 8 is a graph showing amplitude versus time for a superposition of wavelets with a transit time difference between each of 0.05 signal periods and a total transit time difference between first and last wavelets of 0.5 signal periods according to some embodiments.

FIG. 9A is a graph showing amplitude versus time for a superposition of wavelets with a transit time difference between each of 0.09 signal periods and a total transit time difference between first and last wavelets of 0.9 signal periods according to some embodiments.

FIG. 9B is a graph a showing a comparison of the superposition with a transit time spread of 0.9 signal periods between wavelets with that that for zero transit time spread between wavelets.

FIG. 10 is a graph showing third zero-crossing time versus transit time spread in signal periods according to some embodiments.

FIG. 11 is a graph showing signal amplitude reduction versus transit time spread in signal periods according to some embodiments.

FIG. 12 is a graph showing upstream transit time spread versus velocity, according to some embodiments.

FIG. 13 is a graph showing upstream transit time spread versus Mach number (velocity divided by the speed of sound), according to some embodiments.

FIGS. 14A-B includes graphs showing upstream and downstream transit time spread versus velocity divided by the speed of sound raised to the nth power where n=2, according to some embodiments.

FIG. 15A-B includes graphs showing upstream and downstream delay time versus velocity divided by the speed of sound raised to the nth power where n=1.8 in FIG. 15A and n=2 in FIG. 15B, according to some embodiments.

FIG. 16 is a graph showing upstream and downstream delay time versus velocity divided by the speed of sound raised to the nth power where n=2 and the speed of sound equals 400 meters per second, according to some embodiments.

FIG. 17 is a graph showing velocity errors in percentage versus velocity, according to some embodiments.

FIG. 18 is a graph showing velocity errors in percentage versus velocity divided by the speed of sound raised to the nth power where n=1.6, according to some embodiments.

FIG. 19 is a graph showing scaled velocity errors in percentage versus velocity divided by the speed of sound raised to the nth power where n=1.8, according to some embodiments.

FIG. 20 is a graph showing fitted functions for velocity errors in percentage versus velocity divided by the speed of sound raised to the nth power where n=1.6, according to some embodiments.

FIG. 21 is a set of flow diagrams showing operations for correcting flow calculations in the flow measurement system illustrated in FIG. 1, according to some embodiments.

### DETAILED DESCRIPTION

### Overview

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

The present disclosure relates to ultrasonic measurement systems, including, but not limited to, ultrasonic flow meters. Some embodiments provide a flow meter that corrects adverse effects of velocity on ultrasonic transit time measurements in flowing fluids. The fluids can be any type of fluids including but not limited to gases generally, not limited to but including air, CO2, hydrogen and natural gas mixtures etc.

In some embodiments, systems and methods achieve high accuracy measurement using transducers mounted in housings, with those housings incorporated into a pipe wall at an angle such that a semi-cylindrical cavity or recess in front of the housing is equal to or larger in diameter than the transducer housing diameter. As such, the energy associated with the ultrasonic signal that passes from one transducer to the other transducer spends part of the time in the cavity and part of its time in the flowing fluid in some embodiments.

In some embodiments, systems and methods of high accuracy flow measurements adapt to, compensate for, or adjust for one or more effects that have been observed whereby the ultrasonic waveforms become altered with a resulting impact on the measurement of the transit times and/or the velocity derived from such transit times under combined conditions of high velocity and relatively low speed of sound. In the extreme case, the signals waveforms can become so distorted that accurate measurement is not possible or is difficult. In some embodiments, the systems and methods adapt to, compensate for, or adjust for the signal waveform distortion that causes measurement errors due to the one or more effects. These one or more effects can be related to the finite size of the transmitting and receiving transducers and the velocity distribution in the fluid volume that interacts with the received signals. In some embodiments, the systems and methods adapt to, compensate for, or adjust for the effect related to the flow velocity and the physical/acoustic geometry. In some embodiments, the systems and methods adapt to, compensate for, or adjust for the effect according to its dependence on the speed of sound in the fluid. The flow velocity generally refers to a velocity of the fluid at a particular point or area in some embodiments. Flow rate generally refers to a volume of flow passing a point or area in some embodiments.

In some embodiments, corrections are provided that provide better performance than conventional calibration corrections that are solely applied to the average velocity or the average flow rate at the meter level (e.g., a so-called meter factor which is simply the ratio of the wanted or reference flowrate divided by the flowrate indicated by the meter) or at a path level (i.e. where velocity measurement paths are corrected individually). In some embodiments, corrections are applied instead of or in addition to conventional corrections such as prior-art conventional corrections that are applied to account for inexact geometric and timing corrections performed at zero flow and perceived fluid dynamic effects and are applied as a function of flow rate, flow velocity and/or Reynolds number or velocity profile shape. In some embodiments, corrections are applied that provide better performance than conventional calibration corrections because the correction accounts for the effect of finite transducer size described above and its dependence on both flow velocity and sound speed.

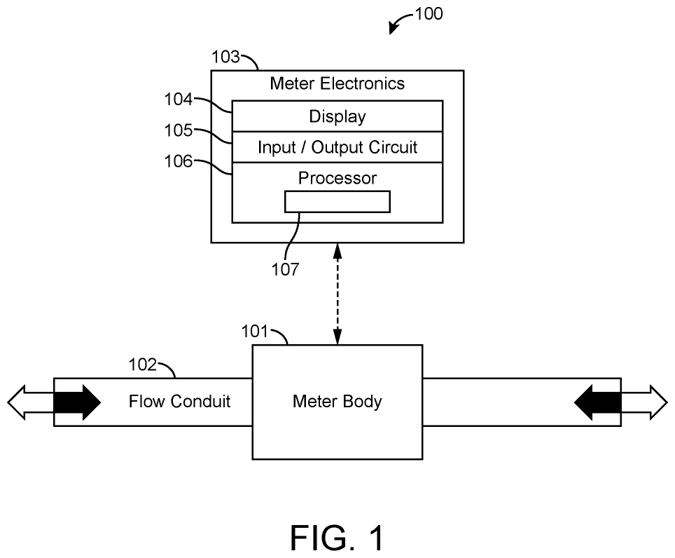

Referring now to FIG. 1, a block diagram of an ultrasonic measurement system 100 is shown, according to some embodiments. In some embodiments, the ultrasonic measurement system 100 includes a meter body 101, a flow conduit 102, and meter electronics 103. The meter electronics 103 may include a display 104 (e.g., LED display or LCD), an input/output circuit 105, and a processor 106. Meter electronics 103 can be any hardware and/or software processor or processing architecture configured to execute instructions and operate on data. Metering electronics 103 can be or can include one or more microprocessors, application specific integrated circuits (ASICs), circuits containing one or more processing components, groups of distributed processing components, circuits for supporting a microprocessor, or hardware devices configured for processing sensor data.

In some embodiments, meter electronics 103 can include a communications interface or input/output circuit 105 for wired or wireless communications interfaces (e.g., jacks, antennas, transmitters, receivers, transceivers, wire terminals, etc.) for conducting data communications. For example, the communications interface can include an Ethernet card and port for sending and receiving data via an Ethernet-based communications link or network. In another example, the communications interface can include a Wi-Fi transceiver for communicating via a wireless communications network. In another example, the communications interface can include cellular or mobile phone communications transceivers.

In some embodiments, meter electronics 103 can include memory (e.g., memory, memory unit, storage device, etc.) that includes one or more devices (e.g., RAM, ROM, Flash memory, hard disk storage, etc.) for storing data and/or computer code for completing or facilitating the various processes, layers and modules described in the present disclosure. The memory can be or include volatile memory or non-volatile memory. The memory can include database components, object code components, script components, or any other type of information structure for supporting the various activities and information structures described in the present disclosure. According to an example embodiment, the memory is communicably connected to processor 106 and includes computer code for executing (e.g., by processing circuit or processor 106) one or more processes described herein.

Processor 106 may be configured to control the sending and receiving of ultrasonic signals, as described in greater detail herein. The processor 106 may be further configured to perform signal and data processing, as well as performing flowrate and output calculation. In some embodiments, the meter electronics 103 may be included in the meter body 101 (i.e., assembled as one unit). In other embodiments, the meter electronics 103 may be mounted on the meter body 101, on the flow conduit 102, or separately. The input/output circuit 105 may include various analogue and/or digital inputs and outputs to perform the systems and methods described herein.

Processor 106 includes a correction module 107 in some embodiments. In some embodiments, correction module 107 is a software module, routine, application, file, or other code for performing the correction task described herein. Correction module 107 is configured to cause processor 106 to adapt to, compensate for, or adjust for the effect associated with ultrasonic waveforms becoming altered with a resulting impact on the measurement of the transit times and the velocity derived from such transit times under combined conditions of relatively high velocity and relatively low speed of sound. Correction module 107 allows meter electronics 103 to provide corrections that provide better performance than conventional calibration corrections and account for the effect of finite transducer size described above and its dependence on both flow velocity and speed of sound.

In some embodiments, the ultrasonic measurement system 100 includes at least one pair of transducers (e.g., transducer assemblies) in pitch-catch operation where a signal is transmitted from one transducer to another. Transducers can be configured as transmitters, receivers, and/or transmitter/receivers. The processor 106 controls the application of an electronic signal to a transmitting transducer and the reception of an electronic signal from a receiving transducer. In addition to controlling the excitation of the transmitting transducer and the acquisition of the receiving signal by the receiving transducer, the processor 106 may perform other functions, such as signal processing and calculation of derived results. The processor 106 may be connected to output devices, which may be included in the input/output circuit 105. The processor 106 may be configured to perform flow measurements based on the determination of the transit times of the ultrasonic signals. Such flow measurement results may be recorded and stored or output in analogue or digital form.

In some embodiments, the ultrasonic measurement system 100 sends ultrasonic signals between pairs of transducers arranged within or around the periphery of a flow conduit. The velocity of the fluid is determined by inferring the transit time of the ultrasound between pairs of transducers by electronic and computational means. To measure with higher accuracy, multiple pairs of ultrasonic transducers may be utilized, forming multiple paths through the flowing fluid. The transducers, due to practical design constraints, have a finite size, and typically have a cylindrical construction including a piezoelectric element in a housing, though many different geometrical arrangements are possible. To measure the axial velocity of the flowing fluid, the path for the ultrasonic signals is disposed at a non-normal angle with respect the conduit axis. To avoid problems of refraction, the transducer can be disposed behind a window or aperture that is parallel with the piezoceramic element and has even thickness. An uneven thickness of window or ‘wedge’ can result in refraction of the ultrasound which imposes undesirable limitations on path geometry and/or undesirable effects on the accuracy of the velocity measurement. A consequence of the parallel window of even thickness, combined with the need for the path to be at an angle to the pipe axis, is that the transducer housing cannot be flush with the wall of the conduit and therefore either protrudes or is recessed in some embodiments. While this design allows for flexibility in the arrangement of the measurement paths, and limits undesirable refraction of the signal, there are secondary effects that occur as a consequence of these practical constraints.

Experience when applying multi-path ultrasonic meters of the chordal type has shown that meters with recessed transducers are prone to adverse effects on the signal that are more severe the higher the velocity, particularly in gas flow applications where the speed of sound is typically lower than that of liquids. Analytical studies and modelling confirm that these effects are related to the finite size of the transducer elements combined with the uneven distribution of velocity in the volume between the transducers that interacts with the ultrasonic signals. Reducing the size of the transducers can alleviate this effect. However, reducing the size of the transducers while maintaining the necessary signal strength and signal-to-noise-ratio for accurate transit time measurement can be difficult.

For a finite and given size of transducer, it can be shown that the magnitude of this effect can be somewhat reduced by choosing an appropriate path angle relative to the central axis of the pipe. However, making such a selection involves a compromise between the accuracy of the measurement at low velocity (where a shallower path angle is preferable, as this results in a longer path and generates larger transit time differences) and high velocity (where the aforementioned effect can be reduced by having a steeper path angle resulting in a shorter path with smaller cavities).

The nature of the high-velocity effect on the signals is such that for a finite, given transducer size, the apparent signal strength diminishes as the velocity increases. The received signal has to be amplified before it can be processed, and even if sufficient amplification is available in the electronics, the signal strength may be so diminished (and hence the signal-to-noise ratio too low), or the waveform shape too distorted, such that the signal cannot be measured reliably.

If, as a non-limiting example, the parameters of the designed ultrasonic measurement system 100 are selected such that a reliable signal can be measured up to 40 m/s using transducers of 20 mm diameter, with a fluid of sound velocity of 300 m/s, then a velocity-dependent error of increasing magnitude exists as the velocity increases towards the limit of operation. If this error was accounted for by applying a meter factor as a function of velocity or volumetric flowrate (by correcting the output of an ultrasonic transit time flow meter), and then the meter was calibrated using a second fluid of higher sound speed, e.g., 400 m/s, the meter would be over-corrected, i.e. the magnitude of the effect at a given velocity and 400 m/s speed of sound is less than that at the same flow velocity and 300 m/s speed of sound.

The effect on the velocity error is not solely a function of velocity nor is solely it a function of Mach number (which is the ratio of the flow velocity, ν, to the speed of sound, c). The Applicant has found that these effects correlate with the flow velocity divided by the speed of sound to the power n, where n is greater than 1 and typically close to 2 in some embodiments. In some embodiments, the measurement results are corrected as a function of the correlation parameter X where the correlation parameter takes a form at least approximately equation to ν/cⁿ. The form of the equation and the specific use of the ν, c and n terms in the correlation parameter may be substituted by like terms that produce a correlation parameter with similar dependence on ν and c in some embodiments. Furthermore, as ν and c can themselves be derived or estimated from the transit time measurements, the correction terms can also be implemented in a form that is a function of the transit time measurements directly without intermediate calculation of ν and c in some embodiments.

Exemplary embodiments described herein provide a way determining and correcting such errors such that improved accuracy is obtained even when the flow measurement device is subject to different operating conditions, particularly in terms of the flow velocity and the speed of sound in the fluid. Using the example of the correlation parameter in the form ν/cⁿ, an exemplary process includes:
a. For each measurement path, or for the flow meter as a whole, the correction terms required for the correction function are determined by testing or modeling the measurement system with variations of ν, the flow velocity and c, the speed of sound.
b. Results at the conditions of interest are evaluated and values for the free variables of the correlation parameter (in this example the exponent n in ν/cⁿ) are selected such that the correction terms become coincident as a function of the correlation parameter X.

In some embodiments, variables for the ν and c dependent correlation parameter X are determined, and the variable of interest (i.e. a correction term such as an error or a correction factor) is modelled or fitted as a function of the correlation parameter. Once the relationship between the correction and the correlation parameter has been determined, the correction term can then be calculated and used in the ultrasonic measurement system 100. For example, if the velocity and speed of sound dependent measurement error for a given transit-time measurement path is determined, the correction can then be applied when ultrasonic measurement system 100 is in use as a function of the correlation parameter with measured input variables that are dependent on both ν and c. In addition to directly calculating corrections terms using the correction function, correction terms could be pre-calculated and stored in look-up tables as a function of ν and c or related parameters. Corrections can be applied to transit times, or results that are derived from those transit times including but not limited to velocity, flowrate and speed of sound in some embodiments.

In some embodiments, the ultrasonic measurement system 100 can be a flow meter such as a CALDON™ ultrasonic flow meter(s) configured for corrections as described herein. The CALDON™ meter uses a compact transmitter enclosure that can be integrally mounted to the meter body or remote mounted. Within the meter body are multiple pairs of fully integrated piezoelectric ultrasonic transducers forming acoustic measurement paths. These paths typically cross the flow stream at an angle of between 45 and 65 degrees so that there is a difference in the transit time of the ultrasonic signals, depending on whether the sound pulse is traveling with or against the direction of flow. The upstream and downstream transit times are measured for each path. The meter's electronics infer velocity on each path and perform an integration of axial velocity to compute an output of volumetric flow rate.

The flow meter can be a self-verifying ultrasonic meter using the principles outlined in U.S. Pat. Nos. 9,304,024, 10,288,462, and 10,393,568 utilizes an electronic signal processing unit and a number of transducers to make multiple measurements of the transit time of ultrasonic pulses sent along specific paths in a flowing fluid. These paths are arranged to allow the meter to make a plurality of axial velocity measurements in each chordal plane of a multipath ultrasonic flow meter in some embodiments. The resulting measurements can be utilized to determine the rate and quantity of flow and also to estimate the uncertainty in that flow rate in some embodiments.

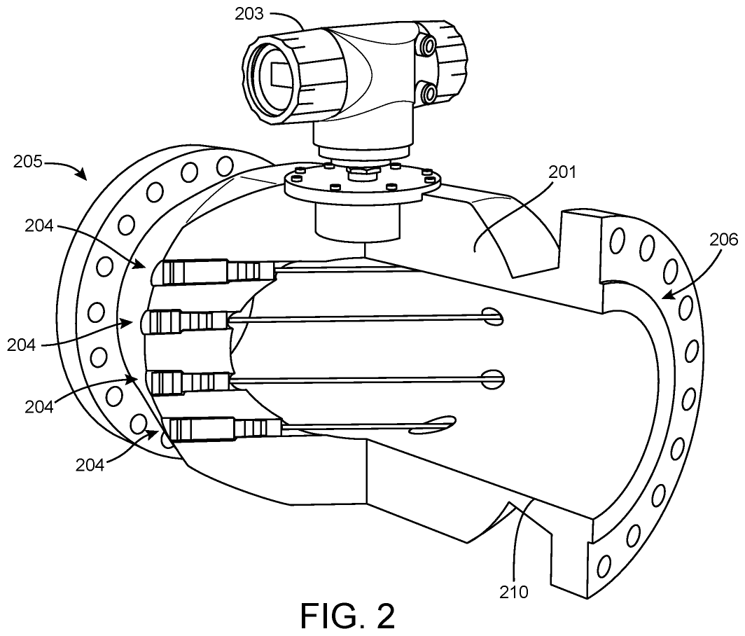

Referring now to FIG. 2, a perspective cross-sectional view of a flow meter 200 is shown according to some embodiments. The flow meter 200 may be identical or substantially similar to the ultrasonic measurement system 100 described above with reference to FIG. 1. In some embodiments, the flow meter 200 includes a flow meter body 201 (e.g., meter body 101 (FIG. 1), flow meter electronics 203 (e.g., meter electronics 103 (FIG. 1), and fluid inlet/outlet ports 205 and 206. While the systems and methods disclosed herein generally refer to ultrasonic flow meters for natural gas or petroleum products—such as the flow meter 200—this is merely meant to be exemplary and should not be considered limiting, as other types of ultrasonic systems may be used with the systems and methods described herein. Ports 205, 206 may act as an inlet port or an outlet port respectively, and/or vice versa.

In some embodiments, the flow meter electronics 203 includes a processing circuit including one or more processors and memory (not shown). The processor can be implemented as a general purpose processor, an application specific integrated circuit (ASIC), one or more field programmable gate arrays (FPGAs), a group of processing components, or other suitable electronic processing components. The flow meter electronics 203 may function substantially similar to the meter electronics 103 depicted in FIG. 1.

In some embodiments, the flow meter 200 includes transducer assemblies 204 arranged upstream and downstream of one another in a pitch-catch relationship to send acoustic energy along an acoustic path through the fluid flowing in a conduit. The transducer assemblies 204 may be disposed within apertures formed by the flow meter body 201. In some embodiments, the transducers may be slightly recessed within the apertures such that the transducer assemblies 204 do not directly interface an inner surface 210 of the flow meter body 201. The flow meter electronics 203 determines the transit times for upstream and downstream signal transmission and uses those measured upstream and downstream transit times in combination with other inputs to calculate the velocity in each measurement plane and to infer the flow rate of the fluid.

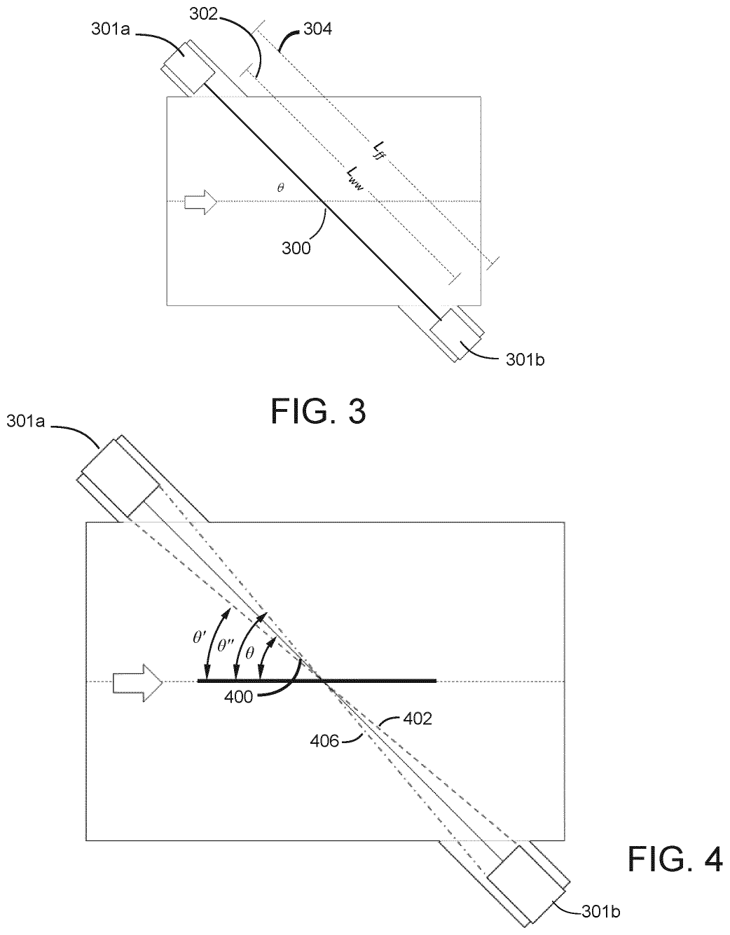

With reference to FIG. 3, ultrasonic transit-time flow velocity measurement can be represented by depicting a straight line 300 joining two transducers 301a and 301b at their centers. Transit times can be measured in both directions, downstream with the flow direction and upstream against the flow direction in some embodiments. The measured transit times are converted to a velocity result according to an algorithm that uses the geometric parameters of the straight-line measurement path in some embodiments. For example, processor 106 (FIG. 1) can use an equation 1 of the form:

$$v = \frac{{L}_{ff}}{2 cos θ} \frac{Δ t}{{t}_{up} {t}_{down}} \qquad ( 1 )$$

### Where:

ν is the measured axial flow velocity on the path
L_{ff} is path length of the path from ‘face to face’ of the transducer housings (line 304)
θ is the path angle relative to the direction of axial flow
tᵤₚ and t_{down} are the measured transit times
Δt=(tᵤₚ and t_{down}).

In an embodiment where transducers 301a and 301b are recessed, processor 106 can use an equation 2 that is adapted to provide the velocity along the part of the path inside the cylindrical bore of the measurement section assuming net-zero flow in the transducer cavities as follows:

$$v = \frac{{{L}_{ff}}^{2}}{2 {L}_{ww} cos θ} \frac{Δ t}{{t}_{up} {t}_{down}} \qquad ( 2 )$$

where L_{ww} (line 302) is wall to wall path length inside the flowing area of the meter body, i.e. equal to L_{ff} minus the total length of the path in the recess/cavities.
Given that the geometric terms (path lengths and path angle) are usually considered to be constants, the processor 106 can use an equation 3 as follows:

$$v = {k}_{v} \frac{Δ t}{{t}_{up} {t}_{down}} \qquad ( 3 )$$

where k_{ν} is the path geometry constant.

Processor 106 can use numerous implementations of the basic equations for transit-time ultrasonic flow measurement, including those based on a more formal solution of the wave equation. In some embodiments, implementations of flow velocity and flow rate calculation use a geometric parameter set for each measurement path, normally defined in terms of path lengths and path angles along similar principles to those outlined above.

When transit times are measured using ultrasonic transducers 301a and 301b of a finite size, it is not only the energy that travels along the line 300 connecting the center of the transducers 301a and 301b that contributes to the signal. In transmission, acoustic energy radiates from an extended area over the surface of the transducer/transducer housing, and likewise in reception, energy impinging on an extended area of the transducer/transducer housing contributes to the received signal waveform.

According to Huygen's principle, essentially the transmitting surface of the transducer 301a or 301b can be considered to be a collection of a large number of point sources, each emitting a wavelet with a spherical wavefront. The wavelets leaving the transmitter propagate through the fluid and impinge on the receiver, where the individual wavelets combine and interact with the receiving transducer to generate the received signal. In the context of measurement of flow velocity on an ultrasonic path, the large collection of wavelets can also be thought of as a large collection of paths, where every point on the surface of the transmitter is connected by a large number of paths to every point on the surface of the receiver.

There can be numerous complex factors that affect transmitting and receiving ultrasonic signals between transducers, including but not limited to considerations such as the form and magnitude of the vibrations at the face of the transmitting transducer. The total ultrasonic signal that is comprised of the wavelets that travel along numerous wavelet paths of different geometries is subject to these considerations as well as the geometric aspects of the transducer arrangement in some embodiments.

Two additional wavelet paths are discussed below for simplicity although large array of possible wavelet paths exist. With reference to to FIG. 4, two additional wavelet paths 402 and 406 along which contributory wavelets can travel have been shown in addition to the central ultrasonic path 400 (e.g., path associated with line 300 in FIG. 3). One wavelet path 406 starts at the inside edge point (i.e. deep in the recess) of one of the transducers' radiating faces and ends at the inside edge point of the other transducer. The second wavelet path 402 starts at the outside edge point of the first transducer and ends at the outside edge point of the second transducer.

The two wavelet paths 402 and 406 have the same face-to-face (or total) length as one another, L_{ff}′=L_{ff}″, but are not the same in terms of how they interact with the flowing fluid. The path 402 has an angle θ′ which is less than the angle of the path 406, θ″, and has a wall-to-wall length L_{ww}′ that is longer than the corresponding wall-to-wall length of the path 406. As such the velocity equation geometric constant, k_{ν}, for the wavelet paths 402 and 406 are different to one another, or in other words, the transit time along the paths 402 and 406 is different to one another when flow is present.

To illustrate the basic nature of the issue, a simplified approach assumes that the transit times along a path are given by equation 4 as follows:

$${t}_{up} = \frac{{L}_{ww}}{c - v \frac{Z}{{L}_{ww}}} + \frac{{L}_{ff} - {L}_{ww}}{c} and {t}_{down} = \frac{{L}_{ww}}{c + v \frac{Z}{{L}_{ww}}} + \frac{{L}_{ff} - {L}_{ww}}{c} \qquad ( 4 )$$

where Z is the projection of the path in the axial direction inside the measurement plane (i.e. Z=L_{ww} cos θ).

If, for example, the width of the plane in which the path is located is 100 mm wide, and the radiating face of the transducer has a radius of 10 mm and orientated at 45 degrees to the central axis and located with one edge aligned with the edge of the measurement plane, the resultant exemplary geometry terms for the central path and the two wavelet paths 402 and 406 in FIG. 4 are given in Table 1 below.

TABLE 1
Wavelet path geometric terms
Effective transducer radius, r

0.01

Plane width, X

| | | |
|---|---|---|
| | 0.1 | |
| θ | θ′ | θ″ |
| 45.0 | 37.9 | 52.1 |
| Z₀ | Z′ | Z″ |
| 0.1000 | 0.1283 | 0.0780 |
| L_{ww0} | L_{ww}′ | L_{ww}″ |
| 0.1414 | 0.1627 | 0.1268 |
| L_{ff0} | L_{ff}′ | L_{ff}″ |
| 0.1614 | 0.1627 | 0.1627 |
| kᵥ₀ | kᵥ′ | kᵥ″ |
| 0.130 | 0.103 | 0.170 |

For these exemplary three path components the sensitivity of the measured transit time to velocity, described by the corresponding k_{ν} factor, varies by a factor of 1.65 according to some embodiments.

Using the Table 1 exemplary geometry terms along with an exemplary flow velocity of 30 m/s and an exemplary speed of sound of 300 m/s, it can be observed that the tᵤₚ and t_{down} values differ for the three different wavelet paths, as shown in Table 2. In computing these results, a homogenous sound velocity and constant flow velocity of 30 m/s in the measurement plane and zero in the cavities can be. Computing the difference between the two extremes (i.e., the transit time spread, tₜₛ), the values are 18.7 microseconds for the upstream transit time and 15.2 microseconds for the downstream transit time in one example. If a signal frequency of 200 kilohertz (kHz) is assumed and the transit time spread is expressed in signal periods, the corresponding values are 3.75 and 3 periods. This simplified example and analysis illustrates two key aspects of the effects described above: first, the effect is stronger on the upstream signals than the downstream, and second, the differences in transit time for the different wavelet paths can be large in terms of signal wavelengths.

TABLE 2
Velocity, v

30

Speed of Sound, c

| | | |
|---|---|---|
| | 300 | |
| tᵤₚ₀ | tᵤₚ′ | tᵤₚ″ |
| 573.94 | 588.61 | 569.87 |
| t_{down0} | t_{down}′ | t_{down}″ |
| 506.94 | 502.55 | 517.71 |
| Δt₀ | Δt′ | Δt″ |
| 67.0 | 86.1 | 52.2 |

Frequency, f

200,000

Transit time spread

| | μS | signal periods |
|---|---|---|
| tₜₛ_{_{—}}ᵤₚ | 18.7 | 3.75 |
| tₜₛ_{_{—}}_{down} | 15.2 | 3.03 |

Table 3 shows three further examples of calculated transit times using the geometry of Table 1. In Table 3, column a, the velocity has been reduced by a factor of three relative to Table 2, and the resulting transit time spread is reduced by a factor of approximately 3, i.e. the transit time spread is close to being in direct proportion to velocity. In Table 3, column b, the speed of sound is doubled and the resulting transit time spread is reduced by a factor of approximately 4. This shows that the transit time spread is approximately proportional to the sound speed squared. In Table 3, column c, the velocity is increased by a factor of 4 relative to the column a and b examples and the transit time spread in the column c is similar to that of the column a.

TABLE 3

| (a) | | | (b) | | | (c) | | |
|---|---|---|---|---|---|---|---|---|
| Velocity, v | | | Velocity, v | | | Velocity, v | | |
| | 10 | | | 10 | | | 40 | |
| Speed of Sound, c | | | Speed of Sound, c | | | Speed of Sound, c | | |
| | 300 | | | 600 | | | 600 | |
| tᵤₚ₀ | tᵤₚ′ | tᵤₚ″ | tᵤₚ₀ | tᵤₚ′ | tᵤₚ″ | tᵤₚ₀ | tᵤₚ′ | tᵤₚ″ |
| 549.45 | 556.82 | 551.03 | 271.85 | 274.70 | 273.28 | 280.70 | 286.14 | 280.12 |
| t_{down0} | t_{down}′ | tdown″ | t_{down0} | t_{down}′ | tdown″ | t_{down0} | t_{down}′ | tdown″ |
| 527.22 | 528.30 | 533.70 | 266.29 | 267.58 | 268.95 | 258.42 | 257.55 | 262.77 |
| Δt₀ | Δt′ | Δt″ | Δt₀ | Δt′ | Δt″ | Δt₀ | Δt′ | Δt″ |
| 22.2 | 28.5 | 17.3 | 5.6 | 7.1 | 4.3 | 22.3 | 28.6 | 17.4 |
| Frequency, f | | | Frequency, f | | | Frequency, f | | |
| | 200,000 | | | 200,000 | | | 200,000 | |
| Transit time spread | | | Transit time spread | | | Transit time spread | | |
| | μS | signal periods | | μS | signal periods | | μS | signal periods |
| tₜₛ_{_{—}}ᵤₚ | 5.8 | 1.16 | tₜₛ_{_{—}}ᵤₚ | 1.4 | 0.28 | tₜₛ_{_{—}}ᵤₚ | 6.0 | 1.20 |
| tₜₛ_{_{—}}_{down} | 5.4 | 1.08 | tₜₛ_{_{—}}_{down} | 1.4 | 0.27 | tₜₛ_{_{—}}_{down} | 5.2 | 1.04 |

Table 4 illustrates some effects of geometry on the transit time spread. In table 4, column a, the effect of reducing the diameter of the radiating face of the transducer by a factor of 2 results in the transit time spread being reduced by a factor of 1.9 relative to the data in Table 1. Table 4, column b shows that increasing the path angle from 45 to 65 degrees reduces the arrival time spread by a factor of 1.2 in the downstream direction and 1.27 in the upstream direction relative to the data in Table 1. Table 4, column c shows that increasing the width of the measurement plane by a factor of 2 increases the arrival time spread by a factor of approximately 1.05 relative to the data Table 1. Table 4 columns a and b show that reducing the size of the radiating surface of the transducer and changing the angle to reduce the size of the cavity/recess both have beneficial effects in terms of reducing the transit time spread in some embodiments. Table 4, column c shows that the transit time spread is relatively insensitive to the width of the measurement plane. The relatively low sensitivity to the width of the measurement plane is important for design of ultrasonic meters in some embodiments because the width of the measurement plane generally scales with the diameter of the meter and/or pipe section in some embodiments.

TABLE 4

| (a) | | | (b) | | | (c) | | |
|---|---|---|---|---|---|---|---|---|
| Effective transducer radius, r | | | Effective transducer radius, r | | | Effective transducer radius, r | | |
| | 0.005 | | | 0.01 | | | 0.01 | |
| Plane width, X | | | Plane width, X | | | Plane width, X | | |
| | 0.1 | | | 0.1 | | | 0.2 | |
| θ | θ′ | θ″ | θ | θ′ | θ″ | θ | θ′ | θ″ |
| 45.0 | 41.2 | 48.8 | 65.0 | 55.5 | 74.5 | 45.0 | 41.2 | 48.8 |
| Z₀ | Z′ | Z″ | Z₀ | Z′ | Z″ | Z₀ | Z′ | Z″ |
| 0.1000 | 0.1141 | 0.0876 | 0.0466 | 0.0687 | 0.0278 | 0.2000 | 0.2283 | 0.1752 |
| L_{ww0} | L_{ww}′ | L_{ww}″ | L_{ww0} | L_{ww}′ | L_{ww}″ | L_{ww0} | L_{ww}′ | L_{ww}″ |
| 0.1414 | 0.1518 | 0.1329 | 0.1103 | 0.1213 | 0.1038 | 0.2828 | 0.3035 | 0.2659 |
| L_{ff0} | L_{ff}′ | L_{ff}″ | L_{ff0} | L_{ff}′ | L_{ff}″ | L_{ff0} | L_{ff}′ | L_{ff}″ |
| 0.1514 | 0.1518 | 0.1518 | 0.1197 | 0.1213 | 0.1213 | 0.3028 | 0.3035 | 0.3035 |
| kᵥ₀ | kᵥ′ | kᵥ″ | kᵥ₀ | kᵥ′ | kᵥ″ | kᵥ₀ | kᵥ′ | kᵥ″ |
| 0.115 | 0.101 | 0.131 | 0.154 | 0.107 | 0.265 | 0.229 | 0.202 | 0.263 |
| Velocity, v | | | Velocity, v | | | Velocity, v | | |
| | 30 | | | 30 | | | 30 | |
| Speed of Sound, c | | | Speed of Sound, c | | | Speed of Sound, c | | |
| | 300 | | | 300 | | | 300 | |
| tᵤₚ₀ | tᵤₚ′ | tᵤₚ″ | tᵤₚ₀ | tᵤₚ′ | tᵤₚ″ | tᵤₚ₀ | tᵤₚ′ | tᵤₚ″ |
| 540.61 | 546.98 | 537.10 | 415.11 | 428.69 | 413.92 | 1081.22 | 1093.96 | 1074.20 |
| t_{down0} | t_{down}′ | t_{down}″ | t_{down0} | t_{down}′ | t_{down}″ | t_{down0} | t_{down}′ | t_{down}″ |
| 473.61 | 470.45 | 478.44 | 383.97 | 382.74 | 395.40 | 947.21 | 940.90 | 956.88 |
| Δt₀ | Δt′ | Δt″ | Δt₀ | Δt′ | Δt″ | Δt₀ | Δt′ | Δt″ |
| 67.0 | 76.5 | 58.7 | 31.1 | 45.9 | 18.5 | 134.0 | 153.1 | 117.3 |
| Frequency, f | | | Frequency, f | | | Frequency, f | | |
| | 200,000 | | | 200,000 | | | 200,000 | |
| Transit time spread | | | Transit time spread | | | Transit time spread | | |
| | μS | signal periods | | μS | signal periods | | μS | signal periods |
| tₜₛ_{_{—}}ᵤₚ | 9.9 | 1.98 | tₜₛ_{_{—}}ᵤₚ | 14.8 | 2.95 | tₜₛ_{_{—}}ᵤₚ | 19.8 | 3.95 |
| tₜₛ_{_{—}}_{down} | 8.0 | 1.60 | tₜₛ_{_{—}}_{down} | 12.7 | 2.53 | tₜₛ_{_{—}}_{down} | 16.0 | 3.20 |

The foregoing discussion and illustrative calculations and exemplary values are presented in order to aid understanding of the underlying effect that results in transit time spread, and do not limit the scope of the invention. In practice the ultrasonic waves propagate in a continuum but the description and modeling of the velocity-dependent effect on the signal in terms of individual rays or wavelet paths is helpful in providing an understanding of the effect.

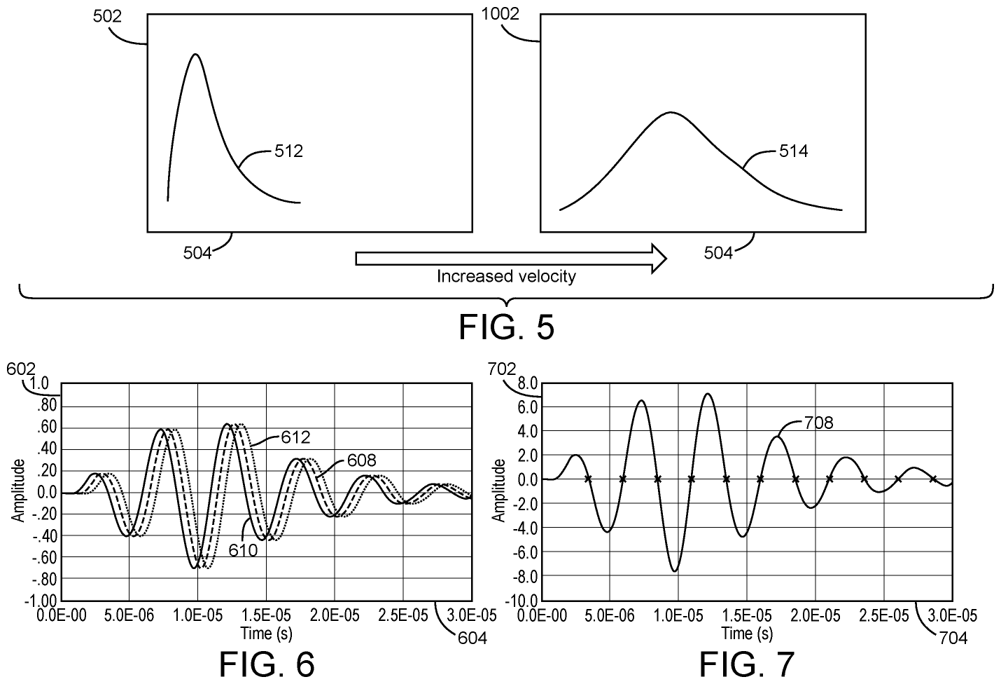

In practice and in a fully three-dimensional implementation, the ray paths connect each point on the transmitting surface to each point on the receiving surface in some embodiments. For every possible starting point on the transmitter, the ray paths fan out to meet with the full surface of the receiver in some embodiments. If the transmitting surface is covered in infinitesimally small simple sources connecting from transmitter to receiver and the geometric terms of each of the resulting wavelet paths is calculated, a continuum of paths defining the connecting volume between transmitter and receiver, each with a corresponding transit time, can be determined in some embodiments. The shortest wavelet paths will be those that travel perpendicular to the transmitting and receiving faces, and these will be abundant in some embodiments. The longest wavelet paths will be from one edge of the transmitter to the diametrically opposite edge on the receiver in some embodiments. Wavelet paths of every conceivable length between these two extremes will exist forming a continuous distribution of wavelet path lengths. Under zero flow conditions the transit times on all wavelet paths of the same length will be the same and the transit times are therefore expected to form a skewed distribution with its highest count towards the end where the transit times are shorter in some embodiments. As the flow velocity increases, the transit times will diverge, as not only are there wavelet paths of different lengths and angles, but there is also a distribution in terms of the proportion of the total length of the paths that is subject to the flow velocity. As a consequence, the distribution of transit times will become wider (and less skewed) as the flow velocity increases, as illustrated schematically and exemplarily in FIG. 5.

With reference to FIG. 5, an x-axis 504 represents transit times and a y-axis 502 represents count of transit times for the various wavelet paths. Line 512 shows a narrower distribution of transit times at a slower velocity as opposed to a wider distribution of the transit times at a faster velocity shown by a line 514.

In some embodiments, processor 106 (FIG. 1) can measure the transit time or arrival time of an ultrasonic signal using any of a variety of techniques. In some embodiments, processor 106 determines the transit time by detecting the first signal peak that crosses a certain threshold level, identifies a particular zero-crossing point relative to that peak, and uses that zero-crossing point as the time marker in the received signal waveform. Various techniques can be used to increase performance associated with these operations. For example, various techniques can be used to increase robustness when the signal is contaminated with noise.

With reference to FIG. 6, an x-axis 604 represents time and a y-axis 602 represents amplitude for three wavelets. Curves 608, 610 and 612 represent the signals for three different wavelets. The three individual wavelets with an approximate frequency of 200 kHz and have a delay of 0.1 signal periods between them. The composite waveform is comprised of a superposition of numerous wavelets and the difference in transit time (the transit time spread) affects the composite waveform which results in the effects discussed above with respect to the ultrasonic measurement system 100 in some embodiments. In this example, the composite waveform is comprised of 11 wavelets, each of identical waveform shape but delayed relative to one another by a given fraction of a wavelength. The first three of the ten wavelets are associated with curves 608, 610, and 612.

With reference to FIG. 7, an x-axis 704 represents time and a y-axis 702 represents amplitude for a composite signal. A curve 708 represents the superposition of eleven wavelets when there is no difference in the arrival time. The resulting waveform has the same form as the individual wavelets represented by curves 608, 610, and 612 (FIG. 6) but an amplitude 11 times as large as shown by curve 708 in some embodiments. Note that the zero crossing positions are marked on curve 708 for a basic method of transit time measurement. The third zero-crossing from the left on curve 708 would be an appropriate selection as the marker for determining the transit time (owing to the relatively amplitude of the peaks either side of it) in some embodiments.

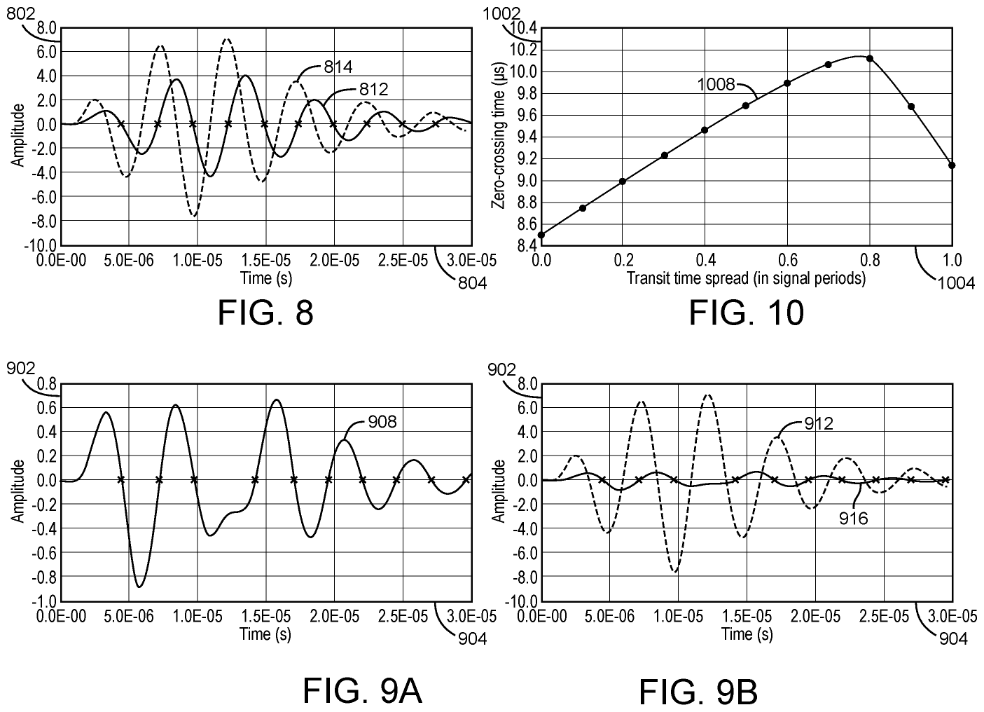

With reference to FIG. 8, an x-axis 804 represents time and a y-axis 802 represents amplitude for a composite signal 812 with a transit time spread of 0.5 signal periods. Curve 812 represents the superposition of the 11 wavelets when the transit time difference between each is 0.05 signal periods (i.e. 0.25 microseconds) and the total transit time spread (between wavelets 1 and 11) is 0.5 signal periods (i.e. 2.5 microseconds) in some embodiments. Curve 814 is the signal for zero transit time spread for reference, i.e., the same signal 708 as shown in FIG. 7. Curves 812 and 814 show that the difference in transit time of the individual wavelets can affect the composite signal in a number of ways, e.g., firstly, the increase in transit time spread diminishes the signal amplitude, and secondly, the transit time spread alters the position of the zero crossing in some embodiments.

With reference to FIGS. 9A-B, an x-axis 904 represents time and a y-axis 902 represents amplitude for a composite signal 908, 916 with a transit time spread of 0.9 signal periods, when the transit time difference between each is 0.09 signal periods (i.e. 0.45 microseconds) and the total transit time spread (between wavelets 1 and 11) is 0.9 signal periods (i.e. 4.5 microseconds). Curves 908 and 916, show that as transit time spread is increased, the effects on the waveform shape relative to the zero-flow reference case 912 are more dramatic when the transit time spread is equal to 0.9 signal periods in total in some embodiments.

With reference to FIG. 10, an x-axis 1004 represents transit time spread time and a y-axis 1002 represents a third zero crossing time for a composite signal. A curve 1008 represents zero crossing time as a function of transit time spread. Curve 1008 shows that the transit time corresponding to the third zero-crossing point varies as the transit time spread increases. The change is approximately linear up to a transit time spread of up to 0.7 signal periods in some embodiments. The linear relationship is expected in this example as the signal amplitude of the wavelets and the time spacing of the wavelets are equal (i.e. the distribution is rectangular). When both the total transit time spread and its distribution are changing, the relationship will not be linear in some embodiments.

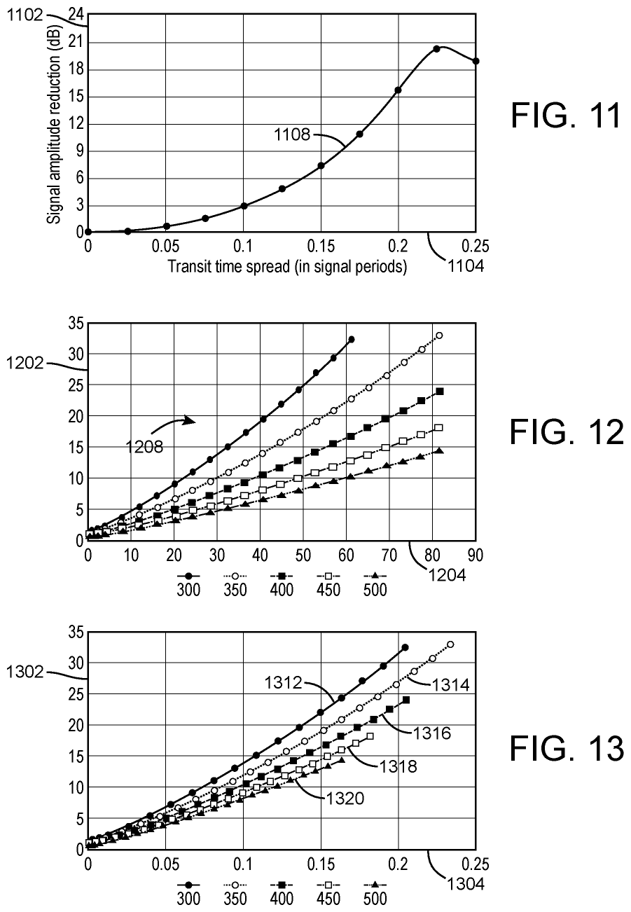

With reference to FIG. 11, an x-axis 1104 represents transit time spread time and a y-axis 1102 represents amplitude for a composite signal. A curve 1108 represents signal amplitude as a function of transit time spread. Curve 1108 shows the reduction in maximum peak signal amplitude with increasing transit time spread in some embodiments. The change in amplitude is exponential up to the point where the spread becomes large and the superposition results in more severe distortion relative to the waveform with zero transit time spread in some embodiments.

Acoustic principles can be employed to model a more complete case where numerous wavelet paths are constructed between two circular radiating/receiving surfaces, the transit times for each of these wavelet paths calculated accounting for the velocity distribution between them, and the resulting signal modeled by performing a convolution of the transit times and the wavelet waveform in some embodiments. Performing this exercise for upstream and downstream propagation, composite signal waveforms can be obtained, and from those waveforms measured transit times can be simulated in some embodiments. Using upstream and downstream signal waveforms, and by calculating these for one or more paths, simulation of the effect for ultrasonic measurement system 100 can be performed in some embodiments. The foregoing and following discussion and illustrative calculations and exemplary values are presented in order to aid understanding of the underlying effect that results in transit time spread and do not limit the scope of the invention.

The embodiments described above are for just some of a myriad of possible geometries that could be used.

### Example I—Meter Geometry

Internal diameter of pipe: 364 mm
Transmitter/receiver radius: 8.5 mm
Path angle: 65°

A single path of a typical four-path meter is simulated in some embodiments. The path is centered on chordal plane that are located according to the second and third abscissa for Gauss-Jacobi integration. The velocity distribution is represented by a power-law velocity profile inside the circular cross-section of the pipe with exponent equal to 7 and zero velocity in the cavities in some embodiments. Simulation results were obtained for sound velocity values between 300 and 500 m/s in 50 m/s increments and the maximum velocity of the power-law distribution was varied between 0.3 and 100 m/s in some embodiments.

With reference to FIG. 12, a y-axis 1202 represents transit time spread (upstream) and an x-axis 1204 represents velocity. A set of curves 1208 represents transit time spread as a function of velocity and speed of sound, where the individual curves represent speed of sound equal to 300, 350, 400, 450, and 500 meters per second (m/s) in some embodiments. It can be observed that the individual curves in FIG. 12 diverge from one another demonstrating that velocity alone is not a good choice of correlation parameter for this effect.

With reference to FIG. 13, a y-axis 1302 represents transit time spread (upstream) and an x-axis 1304 represents Mach number in some embodiments. A set of curves 1312, 1314, 1316, 1318, and 1320 represents transit time spread as a function of Mach number and speed of sound, where the individual curves represent speed of sound equal to 300, 350, 400, 450, and 500 meters per second (m/s) in some embodiments. In comparison to FIG. 12 it can be observed that the individual curves in FIG. 13 are closer together but also that they still diverge from one another. This demonstrates that Mach number would be a better choice for a correlation parameter for this effect than velocity, but that it is also a poor choice of correlation parameter because of the divergence between the curves for different speed of sound values.

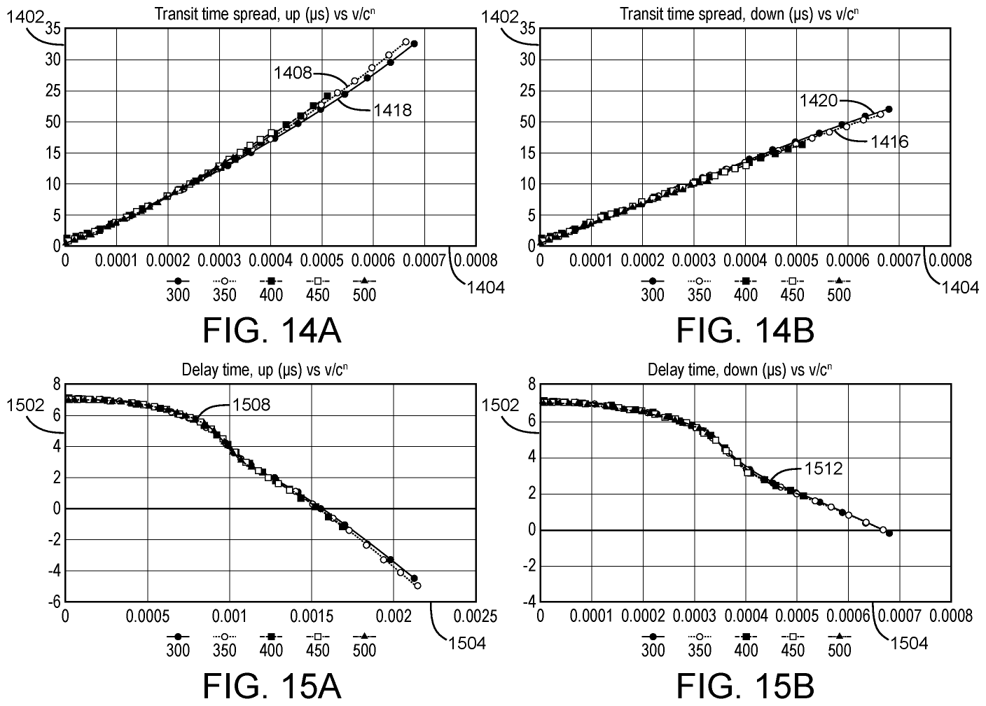

With reference to FIGS. 14A-B, a y-axis 1402 represents transit time spread time and an x-axis 1404 represents the correlation parameter X=ν/cⁿ (with n=2). Results are shown with variation in velocity as described previously with speed of sound values of 300, 350, 400, 450, and 500 meters per second (m/s). Curves 1408 and 1418 represent the transit time spread (upstream) as a function of X=ν/cⁿ in some embodiments. Curves 1418 and 1420 represent transit time spread (downstream) as a function of X=ν/cⁿ in some embodiments. Curves 1408, and 1418 and curves 1416, and 1420 show good agreement between data sets when plotted against the correlation parameter with n=2, and also that the magnitude of effect in the downstream direction is less than that in the upstream direction, as expected from the explanatory model and results of Table 2 according to some embodiments. As discussed above, the transit time spread manifests as an effect on the signal waveform that changes the time of the zero-crossing point relative to where expected using the standard transit time flow equations. The difference between the zero-crossing point and the transit time expected using the standard transit time flow equations can be expressed as a delay time (i.e. the difference between the simulated/measured zero-crossing time and that which is expected from theory) in some embodiments.

With reference to FIGS. 15A-B, a y-axis 1502 represents a delay time and an x-axis 1504 represents the correlation parameter X=ν/cⁿ (where n=1.8 for upstream and n=2 for downstream) in some embodiments. Curves 1512 and 1508 represent the delay time plotted as a function of ν/cⁿ where the speed of sound is 300, 350, 400, 450, and 500 meters per second (m/s). A value of n=1.8 was used for FIG. 15A as this produced a stronger correlation between the data sets in the upstream direction than n=2 according to some embodiments. For FIG. 15 B (in the downstream direction), a value of n=2 was used.

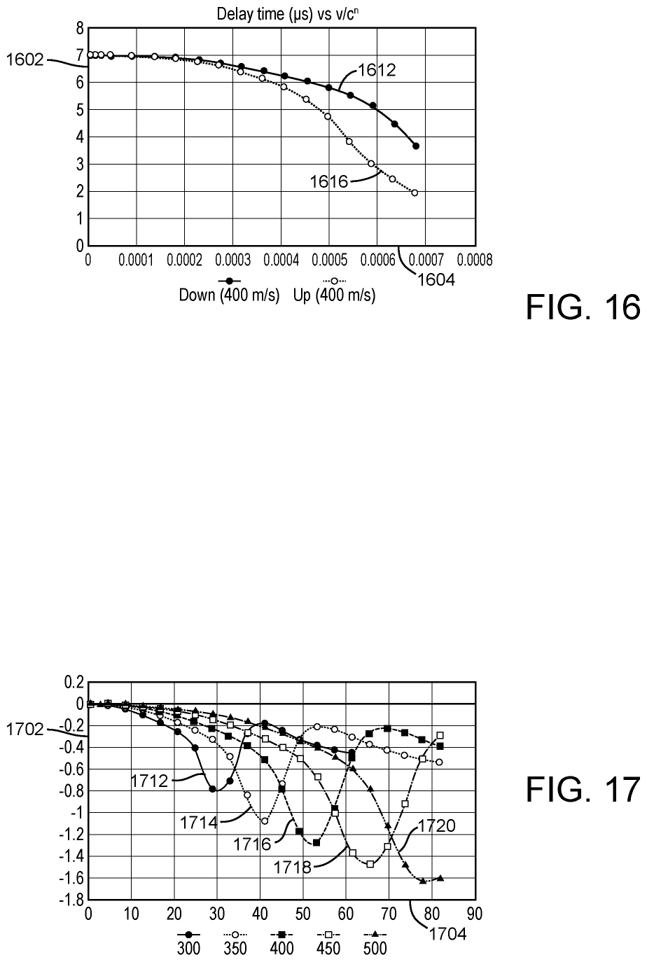

With reference to FIG. 16, a y-axis 1602 represents a delay time and an x-axis 1604 represents the correlation parameter X=ν/cⁿ in some embodiments. Curves 1612 (downstream) and 1616 (upstream) represent the delay time plotted as a function of ν/cⁿ for c=400 m/s plotted versus ν/cⁿ with n=2. Curves 1612 (downstream) and 1616 (upstream) show clearly that the effect on the upstream and downstream transit time measurements is different to one another, and as such the effect can result in simultaneous errors in both the numerator (Δt) and denominator (tᵤₚ multiplied by t_{down}) of the transit time flowmeter velocity equations in some embodiments.

In some embodiments, errors in the transit times owing to this effect will also influence any calculation of the speed of sound that is performed using those same transit times. While the speed of sound calculation performed in an ultrasonic flow meter is normally of secondary importance, correction of transit time or correction of speed of sound directly can proceed in a similar way as the correction that is applied to obtain improved accuracy in the flow velocity and flowrate results in some embodiments.

With reference to FIG. 17, a y-axis 1702 represents velocity errors and an x-axis 1704 represents velocity. Curves 1712, 1714, 1716, 1718, and 1720 represent the velocity errors plotted as a function of velocity where speed of sound is 300, 350, 400, 450, and 500 meters per second (m/s). Curves 1712, 1714, 1716, 1718, and 1720 show that at a velocity of 30 m/s there is a spread of error values from approximately −0.1% at c=500 m/s to −0.8% at c=300 m/s in some embodiments. This spread of errors is significant in practice, for example in custody transfer gas flow measurement where reproducibility of error <0.17% is required for the highest accuracy class of the relevant international standard (See ISO 17098-1 (2019)Measurement of fluid flow in closed conduits—Ultrasonic meters for gas—Part 1: Meters for custody transfer and allocation measurement).

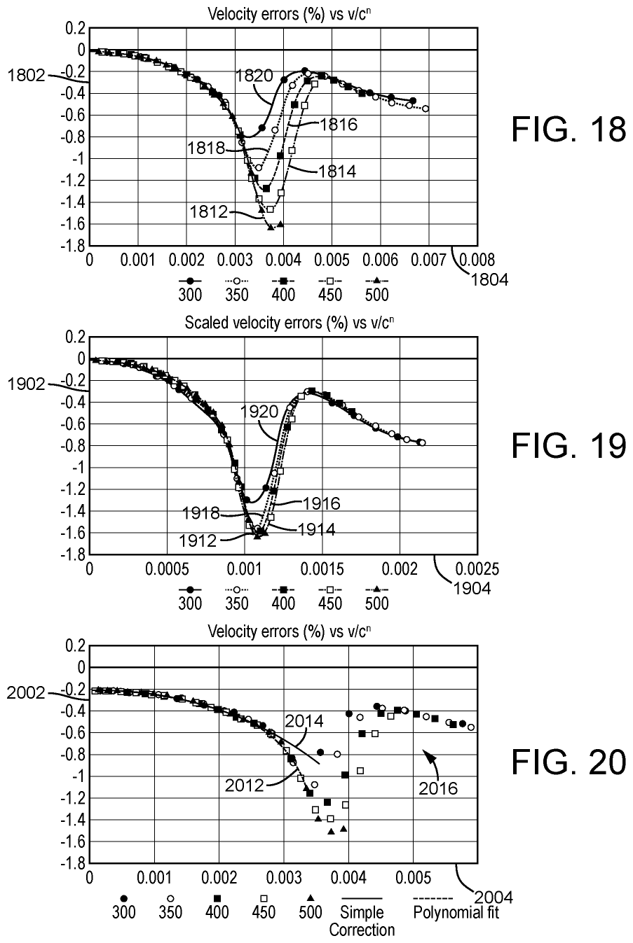

With reference to FIG. 18, a y-axis 1802 represents velocity errors and an x-axis 1804 represents the correlation parameter X=ν/cⁿ in some embodiments. Curves 1812, 1814, 1816, 1818, and 1820 represent the velocity errors plotted as a function of ν/cⁿ where speed of sound is 300, 350, 400, 450, and 500 meters per second (m/s) and where n=1.6. The value of 1.6 for n in the correlation parameter results in a convergence of the results up to the point where the error value reaches approximately 0.8%. With reference to FIG. 19, a correction function fitted over that range could be provided for all values of speed of sound above 300 m/s and for flow velocities below 30 m/s in some embodiments. This is an appropriate range for practical gas flow applications such as natural gas in some embodiments. The correction function or correlation can be applied by correction module 107 (FIG. 1) in some embodiments. The correction function can be a parameter, function, model, or any mathematical construct for correcting or modifying a function or value to reduce error in some embodiments.

With reference to FIG. 19, a y-axis 1902 represents scaled velocity errors and an x-axis 1904 represents the correlation parameter X=ν/cⁿ where speed of sound is 300, 350, 400, 450, and 500 meters per second (m/s) and where n=1.8 in some embodiments. Curves 1912, 1914, 1916, 1918, and 1920 represent the same velocity errors of curves 1812, 1814, 1816, 1818, and 1820 (FIG. 18) with a secondary (y-axis) scaling applied in the form of a multiplier equal to 500 m/s divided by the speed of sound. This effectively normalizes the peak error values in some embodiments. Once normalized in this way, the results are plotted versus ν/cⁿ with n=1.8 in some embodiments. Curves 1912, 1914, 1916, 1918, and 1920 show reasonably good agreement over the full range of conditions simulated and hence could be used for correction over the complete set of conditions in some embodiments. However, as noted above, with increasing transit time spread the signal becomes weaker and more distorted, design constraints may be imposed to limit the maximum expected transit time spread and corresponding signal amplitude reduction in some embodiments.

With reference to FIG. 20, a y-axis 2002 represents velocity errors and an x-axis 1904 represents the correlation parameter X=ν/cⁿ wherein n=1.6 and where speed of sound is 300, 350, 400, 450, and 500 meters per second (m/s) in some embodiments. Curves 2012 and 2014 represent two different functions fitted to the velocity error data that could be used for correction. Note that the functions shown have only been fitted over a limited range of ν/cⁿ selected to be suitable for practical application, but that the full range of data including points 2016, could be fitted with a more complex function such as a curve fitted to the graph of FIG. 19 in some embodiments. The solid line or curve 2014 is in the form of equation 5 below in some embodiments:

$$f ( X ) = {K ( X )}^{m} \qquad ( 5 )$$

where X is the correlation parameter (in this case of ν/c^{1.6}), and the scaling factor K and the exponent m are fitted to the data in some embodiments. The dotted line or curve 2012 is a 5^{th} order polynomial fit with zero-intercept in some embodiments. Many alternative forms of curve fitting may be applied to create an appropriate correction function in terms of the correlation parameter in some embodiments. Correction module 107 can be configured to compute the correction function using the correlation parameter to provide higher accuracy calculations or measurements in some embodiments. The correction function can also be represented by a look up table as a function of velocity and speed of sound or related variables.

The preceding discussion repeatedly uses the correlation function expressed in terms of velocity ν, and speed of sound c. However, it can be noted that the velocity is estimated from the transit time measurements per equations 1 to 3 (or similar) in some embodiments. In some embodiments, the speed of sound can be estimated from the transit time measurements, using, for example, the following equation:

$$c = \frac{2 {L}_{ff}}{( {t}_{up} + {t}_{down} )} \qquad ( 6 )$$

Where a simplifying assumption of ν²<<c² has been applied.
In some embodiments, if a further simplifying assumption is applied to the denominators of both equations (the simplification being that tᵤₚ˜t_{down}=t), then an equation 7 can be expressed as follows:

$$X \approx \frac{v}{{c}^{n}} \approx {k}_{v} \frac{Δ t}{{t}^{2}} / {( \frac{{L}_{ff}}{t} )}^{n} = {k}_{x} \times Δ t \times {t}^{n - 2} \qquad ( 7 )$$

where kₓ is a new geometric constant for the correlation parameter. When expressed in this form when n=2, the correlation parameter X scales directly with the transit time difference Δt, which can be expected since Δt can be shown to be proportional to ν/c² in some embodiments.

Many other variations based on the methods outlined can be used to determine the correlation parameter in some embodiments. One or the other of the velocity and speed of sound dependent terms could be provided by other means, such as from an external source or as a user-selectable configuration input (e.g., for a particular gas species or operating condition) in some embodiments. In some embodiments, correction module 107 is configured to correct for the occurrence of an effect that increases with increasing flow velocity and reduces with increasing speed of sound when estimating flow velocity from ultrasonic transit time measurements using the measured data and one or more functions described above.

In some embodiments, correction module 107 is configured to correlate the effect with a parameter X which is approximately proportional to ν/cⁿ (n>1 or approximately 2) so that the adverse influence of this effect on the accuracy of a transit time-based velocity or flowrate measurement can be corrected. Correction module 107 can utilize various techniques to obtain the correlation parameter (e.g. X), use the correlation parameter in the correction function, and apply the correction term to a measurement result.

In some embodiments, correction module 107, can apply corrections directly to the measured transit time values tᵤₚ and t_{down} prior to calculating Δt and then using the corrected values of tᵤₚ, t_{down} and Δt on that path to calculate the flow velocity using an equation similar to, but not limited to, equation 3. In the case of a multipath flow meter, each path would have the appropriate corrections applied to its transit time measurements, such that each path produces a corrected velocity result, and then those corrected velocity results would be used to compute the flow rate in some embodiments.

In some embodiments, the flow velocity could be calculated using the measured values of tᵤₚ, t_{down} and Δt without correction for the effect described, and then the correction applied to that velocity by correction module 107. In a multipath meter, each path velocity could be corrected individually in some embodiments. The flowrate calculation could then proceed using the corrected velocities in processor 106 in some embodiments.

In some embodiments, the correction could be applied to a composite velocity or flowrate (e.g., a velocity or flowrate that is calculated using the measurement results from multiple paths). In some embodiments, individual path velocities could be calculated without correction for the effect, and those uncorrected velocities then combined to provide a composite velocity (such as a weighted mean velocity) or flowrate. The correction is applied to the composite velocity or to the flowrate that is obtained from the composite velocity in some embodiments.

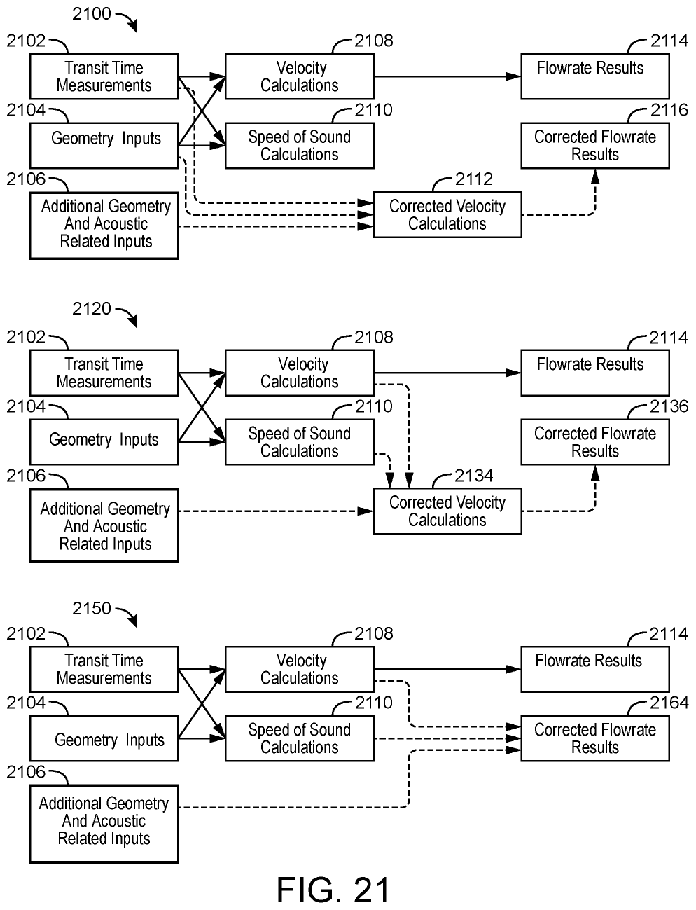

With reference to FIG. 21, metering electronics 103 can utilize a calculation process 2100, 2120, or 2150 to make corrections for the above described effects to provide a higher accuracy flow meter. In some embodiments, corrections can be applied to velocity results or applied directly to the transit time measurements, in which case the corrections will also improve the calculation of the speed of sound. In some embodiments, a speed of sound can be calculated using uncorrected transit time measurement and can then be corrected as a function of X, similar to the processes described for velocities and flowrates.

According to processes 2100, 2120, and 2150, transit time measurements are made by processor 106 in operations 2102, geometric inputs are received in an operation 2104, and additional geometric inputs are received in operation 2106. The geometric inputs associated with operation 2104 can be received or stored in metering electronics 103. The geometric inputs associated with operation 2104 can be associated with ultrasonic metering systems (e.g., Caldon meters). For example, parameters such as the path lengths and path angles can be provided. The inputs are associated with metering algorithms. In some embodiments, the additional geometric and acoustic inputs of operation 2106 are associated with the finite size and/or other characteristics of the transducers and path arrangement. In an operation 2108, velocity calculations are made. The velocity calculation can be made according to algorithms associated with ultrasonic metering systems (e.g., Caldon meters) and can use data from operations 2102 and 2104. In an operation 2110, speed of sound calculations are made. Operation 2112 uses data from operations 2102,2104 and 2106. In some embodiments, flow rate determinations without using the corrections described herein can be calculated in an operation 2114. The results can be saved for comparison to corrected calculations as described herein in some embodiments.

In process 2100, an operation 2112 provides corrected velocity calculations. The corrected velocity calculations are provided to operation 2116 to provide corrected flow rates in some embodiments. In some embodiments, operation 2112 does not use data from operation 2108 and uses corrected transit time measurements to calculate corrected velocity (e.g. directly calculates corrected velocity from transit time measurements 2102, geometric parameters 2104 and additional inputs 2106). To calculate flow rate from velocity, an area term (normally based on a diameter, which can be included in the standard geometry inputs of operation 2104) is used in some embodiments.

In process 2120, operation 2134 provides corrected velocity calculations using data from the speed of sound calculation of operation 2110, velocity calculations of operation 2108 and additional geometric/acoustic inputs of operation 2106. The corrected velocity calculations are provided to operation 2136 to provide corrected flow rates in some embodiments.

In process 2150, operation 2164 provides corrected flow rate calculations using data from the speed of sound calculation of operation 2110, velocity calculations of operation 2108 and additional inputs of operation 2106 in some embodiments. The uncorrected velocity calculations in operation 2108 are provided to operation 2164, and these velocities plus speed of sound calculations in operation 2110 and the additional inputs 2106 are used to calculate a flow rate correction function and hence provide corrected flow rates in some embodiments.

In some embodiments, appropriate implementation of the corrections requires the exponent n in the correlation parameter X to be known and the magnitude and form of the error or correction factor as a function of X to be known. In flows 2100, 2120, and 2150, within certain limits the velocity correction can be represented by a simple function of form K(X)^{m} in some embodiments. Although only three correlation parameters (e.g., n, K and m) are required to calculate a correction term corresponding to a particular measurement configuration (which could be a single measurement path or multipath measurement system) in some embodiments, additional correlation input parameters can be utilized. For some embodiments of an ultrasonic transit time measurement configuration, the required parameters for correction could be determined by means of simulation and/or calibration. The results shown FIGS. 12-20 provide examples of determination of the effects by simulation. Such results could be used as a way of obtaining the form of the correction function and parameter values for implementation in a practical measurement device in some embodiments.

In some embodiments, a calibration of the physical device could be performed under flowing conditions with variation of both the flow velocity and the speed of sound, and with availability of reference values of both. Using the reference values of flow rate and/or velocity and speed of sound, the expected transit times and/or velocity and/or flowrate results can then be compared with the actual results, and the required correction terms calculated in some embodiments. The correction terms can be errors in absolute or relative terms, or correction factors in the form of a ratio of expected and actual results, or could take a different form in some embodiments. The correction terms can be evaluated/examined relative to the correlation parameter X and the correlation inputs (such as the exponent n, or the magnitude scaling term used for presentation of FIG. 19) determined such that the correction terms are strongly correlated as a function of Xin some embodiments. While the simulated results shown in FIGS. 12 to 20 were obtained at multiple velocities and five intervals of speed of sound, in practice the correction terms could be obtained with much less data or with more data. For example, as few as four results (two flow velocities at each of two speed of sound values) could be used to fit an equation of the form:

$$f ( \frac{v}{{c}^{n}} ) = {K ( \frac{v}{{c}^{n}} )}^{m} \qquad ( 8 )$$

As the effect is predominantly a function of the geometric characteristics of a given system (in addition to factors such as the transducer frequency and waveform), once established for a particular system, the corrections can then be applied to other instances of the same design. In some embodiments, if established by calibration, it is not necessary to calibrate every flow meter to determine this effect, it is only necessary to establish the corrections for a given design so that the correction can then be applied to each device of the same design. Furthermore, given the ability to simulate different configurations, or to accumulate data for systems with different but known geometric variations, it is also possible to interpolate or extrapolate the correction functions to situations where calibration data is not available in some embodiments. As noted above the correction terms using a correction function and correlation parameter can be calculated in some embodiments. In some embodiments, the correction function is expressed as a look up table in terms of both velocity and speed of sound or related parameters. The correction terms are obtained from the table and used with or without interpolation between tabulated values in some embodiments.

### Configuration of Exemplary Embodiments

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, any processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures, and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the apparatus as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. An ultrasonic measurement system, comprising:
a plurality of transducers configured to provide ultrasonic signals; and
metering electronics configured to receive electronic signals associated with the ultrasonic signals, wherein the metering electronics are configured to use a correction function being a function of measured or estimated values at least partially dependent on both flow velocity and speed of sound.

2. The ultrasonic measurement system of claim 1, wherein the correction function comprises a correlation having a velocity related term with an exponent greater than zero on a numerator and a speed of sound related term with an exponent greater than zero on a denominator or vice-versa.

3. The ultrasonic measurement system of claim 2, wherein the exponent for the velocity related term is between 1 and 3 and the exponent for the speed of sound related term is between 1 and 3.

4. The ultrasonic measurement system of claim 1, wherein the correction function comprises a correlation having a form of X=ν/cⁿ with n between 1 and 2, ν is velocity and c is the speed of sound.

5. The ultrasonic measurement system of claim 4, wherein n is not an integer.

6. The ultrasonic measurement system of claim 1, wherein the flow velocity is determined using measurements of ultrasonic transit time using the electronic signals.

7. The ultrasonic measurement system of claim 1, wherein the speed of sound is determined using measurements of ultrasonic transit time using the electronic signals.

8. The ultrasonic measurement system of claim 1, wherein a correlation parameter is determined using measurements of ultrasonic transit time using the electronic signals.

9. The ultrasonic measurement system of claim 8, wherein the correlation parameter is proportional to the difference in transit time between signals sent upstream and downstream along a path.

10. The ultrasonic measurement system of claim 1, wherein the correction terms are applied to transit time measurement results directly.

11. The ultrasonic measurement system of claim 1, wherein the correction terms are applied to transit time measurement results indirectly, whereby the correction is applied to a variable derived from the transit time measurement.

12. The ultrasonic measurement system of claim 1, wherein the correction is applied to a velocity variable.

13. The ultrasonic measurement system of claim 1, wherein the correction is applied to a speed of sound variable.

14. The ultrasonic measurement system of claim 1, wherein the correction is applied to a flow rate.

15. A method of determining a corrected flow rate, the method comprising
providing ultrasonic signals in a conduit associated with a flow;
determining ultrasonic transit time using the ultrasonic signals;
determining a correction term using a velocity parameter and a speed of sound parameter; and
determining the corrected flow rate, wherein the correction term is applied to the ultrasonic transit time, a velocity calculated from the ultrasonic transit time, or a flow rate when determining the corrected flow rate.

16. The method of claim 15, wherein the correction term is applied to the velocity to provide a corrected velocity for use when determining the corrected flow rate.

17. The method of claim 15, wherein the correction term is applied to the transit time to provide a corrected velocity measurement for use when determining the corrected flow rate or the correction term is provided using a look up table.

18. The method of claim 15, wherein a correlation parameter used to obtain the correction term has a velocity related term with an exponent greater than zero on a numerator and a speed of sound related term with an exponent greater than zero on a denominator or vice-versa.

19. The method of claim 18, wherein the exponent for the velocity related term is approximately 1 and the exponent for the speed of sound related term is between approximately 1 and 2.

20. The method of claim 15, wherein the correction parameter takes a form of X=ν/cⁿ with n between 1 and 2, ν is velocity and c is a speed of sound.

21. A flow meter, comprising:
a meter body;
plurality of ultrasonic transducers disposed in the meter body; and
metering electronics configured to:
determine ultrasonic transit time using the ultrasonic signals in the meter body;
determine a correction term using a velocity and a speed of sound parameter; and
determine a corrected flow rate, wherein the correction term is applied to the ultrasonic transit time, a velocity calculated from the ultrasonic transit time, or a flow rate when determining the corrected flow rate.

22. The flow meter of claim 21 wherein the correction function uses a correlation parameter having a velocity related term with an exponent greater than zero on a numerator and a speed of sound related term with an exponent greater than zero on a denominator or vice-versa.
